(19) United States
(12) Patent Application Publication
(10) Pub. No.: US 2007/0273139 A1
(43) Pub. Date: Nov. 29, 2007

(54) Device for Ascertaining an Occupant Position in a Vehicle

(75) Inventors: Alfred Kuttenberger, Hessenberg (DE); Marc Theisen, Besigheim (DE); Michael Bunse, Vaihingen/Enz (DE)

Correspondence Address: KENYON & KENYON LLP, ONE BROADWAY, NEW YORK, NY, 10004, US

(73) Assignee: ROBERT BOSCH GMBH, Stuttgart (DE)

(21) Appl. No.: 10/575,315

(22) PCT Filed: Jul. 22, 2004
(86) PCT No.: PCT/DE04/01616

§ 371 Date: May 8, 2007

(30) Foreign Application Priority Data
Oct. 8, 2003 (DE) 103 46 625.8

(51) Int. Cl. B60R 22/46

(52) U.S. Cl. 280/806; 340/668; 701/45

(57) ABSTRACT

Provided is a device for ascertaining an occupant position in a vehicle by measuring the extension of a seat belt, the device conducting the measurement as a function of time.

### FIELD OF THE INVENTION

The present invention relates to a device for ascertaining an occupant position in a vehicle.

### BACKGROUND INFORMATION

It is already known from German Published Patent Application No. 100 05 010 that an occupant position can be determined, using the belt extension.

### SUMMARY OF THE INVENTION

The device of the present invention for ascertaining an occupant position in a vehicle has the advantage over the related art that monitoring the belt extension as a function of time allows a much more accurate measurement than in systems available today. This allows a more effective determination of the occupant position of the specific person or the object. In particular, when monitoring as a function of time, it is possible to make a more effective prediction regarding the person on the vehicle seat, especially in regard to his or her occupant class. Therefore, it is particularly possible to make a distinction as to whether the person is, for example, a 5% woman or a heavy person. Monitoring as a function of time allows the normal position to be easily detected, using pattern recognition. Consequently, it is possible to precisely determine active forward displacement of the occupant. Even objects such as child seats may easily be detected or verified, using belt extension that is constant over time.

It is particularly advantageous that the seat-belt force is also monitored as a function of time. This allows different patterns in the time characteristic of the belt extension and, correspondingly, the belt force to be detected more effectively. In this manner, the belt-fastening procedure, a resting phase, and active forward displacement may be precisely identified.

In addition, it is advantageous that the resting position is determined on the basis of a Muter comparison of the time characteristic. In this context, the application of a belt force via an actuator may be particularly helpful for minimizing belt slack. If the belt extension changes to only a negligible extent over a relatively long period of time, then this position may be identified as the resting position. Deviations from this constitute active forward displacement.

Furthermore, it is advantageous that the belt-extension rate is additionally determined. This is a parameter for determining the behavior of the occupant even more precisely.

The device is advantageously coupled to restraining devices, in order to trigger the restraining devices as a function of a signal of the device. Such restraining devices include irreversible restraining devices, such as airbags and pyrotechnic belt tensioners, but also reversible restraining devices, such as a reversible belt tensioner that may be operated, for example, by an electric motor. For example, in the case of a so called out-of-position, i.e. forward displacement of the occupant into the region of a front airbag, such a front airbag may not be triggered in a collision, in order to spare the occupant injuries from the airbag. A headrest and knee impact bolster are also reversible restraining devices, which are triggered as a function of a signal of the device.

Finally, it is also advantageous that a signal of the device may be used to verify results of other devices for determining the occupant position. Such other devices may include occupant detection via video, ultrasonics, or a weight-sensor system such as load cells.

### BRIEF DESCRIPTION OF THE DRAWINGS

FIG. 1 shows a block diagram of the device according to the present invention.

FIG. 2 shows a flow chart.

FIG. 3 shows a further block diagram.

FIGS. 4a and b show two typical time characteristics of the belt extension.

### DETAILED DESCRIPTION

A few systems for monitoring the occupant position are presently on the market. These include a sensor mat for detecting the weight profile of the object on the vehicle seat, as well as an ultrasonic occupant-position detection system. The developments are primarily concentrated on image-processing systems, but also on weight-based systems.

Reversible belt tensioners allow absolute belt extension to be determined, using at least the relative change in belt extension.

According to the present invention, the time characteristic of the belt extension is used to characterize the occupant position and occupant movements. This characterization may be used for triggering reversible and irreversible restraining devices in a manner appropriate to the situation, for the purpose of occupant protection during an accident. In this connection, the information may be used, on one hand, to verify the data of another system for monitoring the occupant position. The information may also be evaluated directly.

In particular, reversible belt tensioners supply information on the current belt extension, which is used in an algorithm to characterize the position and the movement of the occupant. In the case of the reversible belt tensioners, which are increasingly advancing into the market and are used in the present invention as both sensors and actuators, a considerable advantage of the present invention is that it may provide increased comfort and increased safety to the occupant.

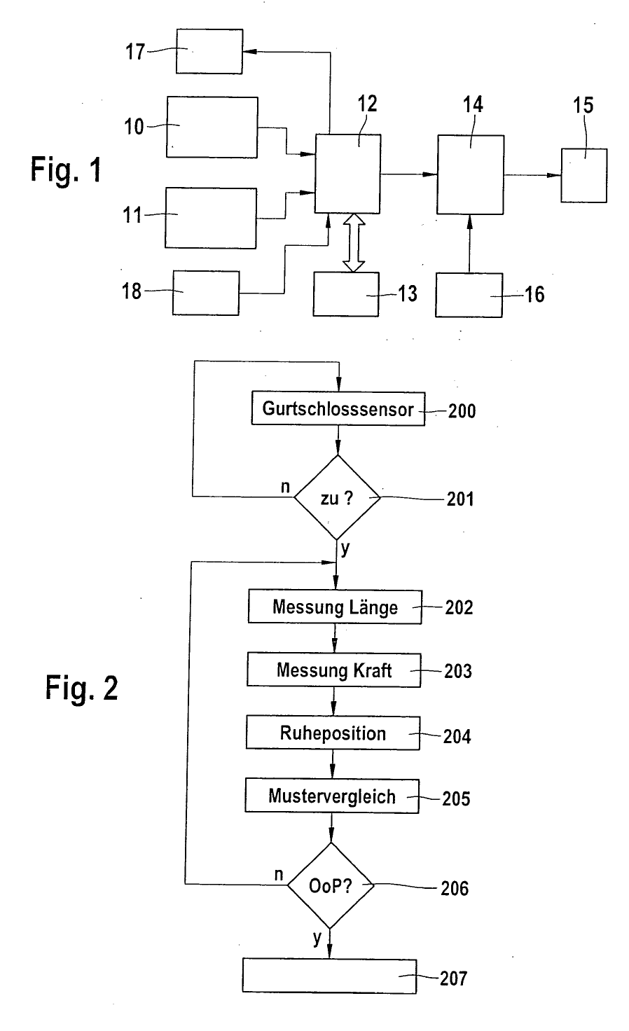

FIG. 1 shows the device according to the present invention in a block diagram. A belt-extension sensor 10 is connected to a processor 12 via a first data input. A belt-force sensor 11 is connected to a second data input of processor 12. A seatbelt-buckle sensor 18 is connected to a third data input of processor 12. Processor 12 is connected to a memory 13 via a data input/output. Processor 12 is connected to an actuating system of belt tensioner 17 via a first data output. Processor 12 is connected to control unit 14 for restraining devices via a second data output. A sensor system 16 is connected via a second data input of control unit 14. Control device 14 is connected to restraining means 15 via a data output.

Belt-extension sensor 10 may be, for example, a reversible electromotive belt tensioner, which supplies both the belt extension and the belt-extension rate, using the motor position and velocity.

Belt-force sensor 11 supplies the measured belt force. As an alternative, belt-force sensor 11 may also be dispensed with when the applied belt force is known from actuating system 17. Belt-buckle sensor 18 supplies a signal as to whether or not the belt buckle is closed. Processor 12 now evaluates the belt extension, and optionally the belt-extension rate and the belt force, as a function of the time characteristic. By comparing these to patterns, processor 12 determines if the occupant has been actively displaced in the forward direction. Processor 12 uses data from its memory 13 for the pattern comparison. In order to eliminate belt slack, processor 12 triggers actuator 17 so that a suitable force is applied to the reversible belt tensioner. If forward displacement has occurred, then processor 12 transmits this datum to control unit 14 via a data line, e.g. a data bus or a point-to-point connection, so that control unit 14 may trigger restraining devices 15, such as airbags, belt tensioners, or knee impact bolsters or head restraints, as a function of this signal. However, control unit 14 only does this when sensor system 16 detects a crash or an imminent crash. In addition to crash sensors, such as acceleration sensors that are distributed in the vehicle, sensor system 16 also includes precrash sensors, such as radar, ultrasonic, and video. Other systems for detecting occupants or detecting position are also subsumed in sensor system 16.

An important task that processor 12 must perform is the activation of the reversible belt tensioner, for example a slight increase in force after the seat belt is fastened, in order to ascertain a normal value of the belt extension specific to the occupant in question. During operation, this procedure may also be used for correcting or optimizing the characterization of normal operation. Occupants can certainly change their sitting positions during a trip. A situation particularly suitable for this is, for example, when the occupant, e.g. after operating a switching element in the passenger car, has gone back into the normal position. The belt slack, which may have been increased by the movement, is decreased again by a gentle increase in force, and a new normal value is ascertained. This may be used for verifying and also correcting the old normal value. If the occupant moves far forward from the normal position into the inflation region of the airbag, this is shown by a markedly increased belt extension. In an occurrence of short duration, the activation of airbags for the corresponding person may be suppressed or limited to light stages of the airbag when, e.g. a crash simultaneously occurs.

Along with the information on the sitting position, such as the seated height, backrest position, and seat displacement, the distance from the various airbags may be ascertained from the belt extension.

The data ascertained here may be verified when an occupant monitoring system is simultaneously present. This allows, for example, reciprocal monitoring for functionality or malfunctions.

These data may also be verified in conjunction with an occupant classification system, for example a weight-sensing system. If, for example, a child seat is detected by the weight-measuring system, this is confirmed, on one hand, by characteristic belt extensions, but primarily by the low dynamic response and the constant normal position and standard belt slack. However, if large-scale variations of the belt extension occur during the trip, then one must assume that the classification is incorrect. In addition, it is possible to detect a child-seat bucket from the belt extension and the weight information.

FIG. 2 shows a flowchart of the functional sequence, through which the device of the present invention may run. In method step 200, belt-buckle sensor 18 determines whether or not the belt buckle is closed. This is checked in method step 201. If this is not the case, then method step 200 is repeated. However, if this is the case, then the method proceeds to method step 202 in order to carry out the measurement of the belt extension. The force is measured in method step 203. In method step 204, the resting position is determined as described above. The pattern comparison is then carried out continuously in method step 205, in order to characterize the behavior of the occupant. In method step 206, it is checked if the occupant is out of position, i.e. in the inflation region of the airbag. If this is the case, then a signal, e.g. for suppressing a corresponding airbag or outputting a warning, is generated in method step 207. However, if the occupant is not in the inflation region of the airbag, then the method returns to method step 202.

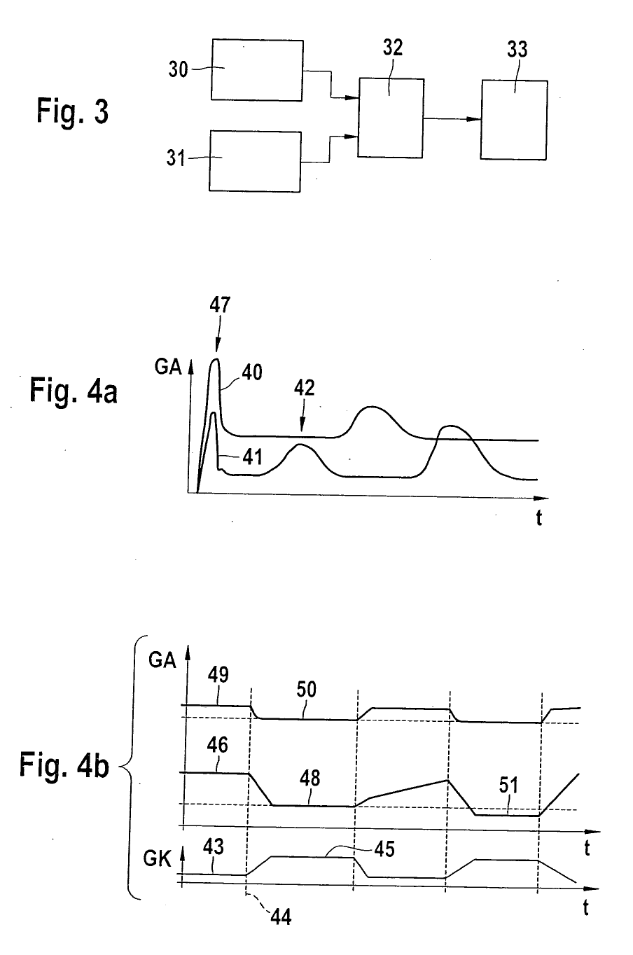

In a further example, FIG. 3 shows how device 30 for verifying a different system of occupant detection 31 may be used. In this context, the signals of these two systems are evaluated by a control unit 32, in order to determine, according to rules, which results are plausible and which have resulted in a faulty classification. This is then transmitted to an airbag control unit 33.

Two typical curves of the belt extension are shown in FIGS. 4a and b. In FIG. 4a, the belt extension is plotted on the ordinate, while the abscissa represents the time axis. Curve 40 is the belt extension of a heavy person as a function of time. Curve 41 is the belt extension of a 5% woman as a function of time. The fastening of the seatbelt occurs at time 47, which is why a pulse in the belt extension occurs. This is the case for the two curves 40 and 41. The 5% woman is leaning forward at time 42, which results in an increase in the belt extension.

However, the corresponding resting phases allow it to be recognized that this is an active forward movement of the person and not a correspondingly heavy person in his or her resting position P. A forward displacement of the heavy person is also shown once in curve 40, which means that in this case, the airbag may be suppressed. The end of curve 41 shows a belt extension that is so large, that it exceeds that of curve 40. This shows that it is necessary to view the belt extension in a dynamic manner, in order to correctly interpret the results of the measurement of the belt extension.

FIG. 4b shows a comparison of a person and a child seat during the execution of a chronological sequence of controlled changes in the belt-force (GK). In this connection, standard belt force 44 is slowly increased to a level 45 at a specific time 44, and belt extension (GA) is measured in the process.

In the case of people, belt extension 46 in the normal resting position, which is normally assumed, for example, after the seat belt is fastened, correlates with height and body circumference to a relatively high degree. In this position, the belt slack caused by clothing may be considerably reduced to a lower level 48 by a relatively small force. In this connection, the gradual compression of clothing causes the attainable shortening of the belt to increase with the applied force. In the case of a slow increase of force, a characteristic, slow reduction in the belt extension is observed.

In the case of a rearwardly installed child seat, belt extension 49 is typically very large, since the belt is guided around the entire seat bucket. Since the low standard belt force already causes the belt to sit effectively and only a small amount of belt slack to be present, an increase in force only allows a small decrease in the belt extension. In particular, even when the belt force is further increased, the lack of compressibility of the material does not allow any further decrease in belt extension 50 to be obtained. A further characteristic distinction is made by the characteristic that no change in minimum belt slack 50 is to be expected when the belt-slack reduction procedure is repeated for a child seat. However, when the seat is occupied by a person, slight changes in the seating position cause a larger deviation in minimum value 51 to be observed.

1.-7. (canceled)

8. A device for ascertaining an occupant position in a vehicle, comprising:
an arrangement for performing a measurement, as a function of time, of a seat-belt extension.

9. The device as recited in claim 8, further comprising:
an arrangement for measuring a belt force as a function of time for ascertaining the occupant position.

10. The device as recited in claim 8, further comprising:
an arrangement for detecting a resting position of the occupant by comparing a time characteristic of the belt extension to a pattern.

11. The device as recited in claim 10, wherein the arrangement for detecting detects the resting position by reducing a belt slack.

12. The device as recited in claim 8, further comprising:
an arrangement for coupling to a restraining device in such a manner, that the restraining device is triggered as a function of a signal of the device.

13. The device as recited in claim 8, wherein for purposes of verification, the device is coupled to at least one other device for determining the occupant position.

14. The device as recited in claim 8, further comprising:
an arrangement for determining a belt-extension rate.
